(19) United States
(12) Patent Application Publication
(10) Pub. No.: US 2011/0165444 A1
(43) Pub. Date: Jul. 7, 2011

(54) SORT OF LI-ION POWER CELL

(75) Inventors: Chuntai Guo, Tianjin (CN); Dingkai Yuan, Tianjin (CN); Yiwei Wang, Tianjin (CN); Chiwei Wang, Tianjin (CN)

(73) Assignee: TIANJIN EV ENERGIES CO., LTD., Tianjin (CN)

(21) Appl. No.: 12/933,141

(22) PCT Filed: Apr. 28, 2010
(86) PCT No.: PCT/CN10/72276

§ 371 Date: Sep. 17, 2010

(30) Foreign Application Priority Data
Apr. 30, 2009 (CN) 200920153839.3

(51) Int. Cl. H01M 4/00; H01M 2/30

(52) U.S. Cl. 429/94

(57) ABSTRACT

A Li-ion power cell includes at least two winding cores produced by a winding process. Each of the winding cores has an anode tab and a cathode tab. The anode tabs and the cathode tabs of the respective winding cores are connected in parallel, respectively. The winding core is of cylindrical or diamond shape. The Li-ion power cell further includes a housing, an anode pole and a cathode pole which are disposed on the housing. The anode tabs of the respective winding cores are connected in parallel and then electrically connected to the anode pole, and the cathode tabs of the respective winding cores are connected in parallel and then electrically connected to the cathode pole.

The present application claims benefit of the priority to CN application No. 200920153839.3 titled “A LI-ION POWER CELL”, filed with the Chinese State Intellectual Property Office on Apr. 30, 2009. The entire disclosure thereof is incorporated herein by reference.

### FIELD OF THE INVENTION

The present disclosure relates to a battery, and more specifically to a Li-ion (lithium-ion) power cell.

### BACKGROUND OF THE INVENTION

The Li-ion cell is a new type of cell developed in the 20^{th} century. In recent years, the Li-ion cell has been widely applied in small military and civilian electrical devices such as a mobile phone, a portable computer, a video camera and a camera due to its advantages of a high specific energy, a stable discharge voltage, no memory effect and environmental protection, as a substitute for the traditional cell. Currently, a large-capacity Li-ion power cell (having a capacity of more than 10 Ah) has been used in electric vehicles on trial, and will become one of main power supplies of electric vehicles in the 21^{th} century. In addition, the large-capacity Li-ion power cell has broad prospects in the satellite, aviation and aerospace, and energy storage.

To promote the use of Li-ion power cell in electric vehicles, it becomes a problem generally concerned in the industry to increase cell capacity. Typically, a method of laminating a plurality of plate electrodes is employed in the power cell to increase cell capacity to a required level. In this method, an anode plate electrode, an insulation film and a cathode plate electrode are laminated in sequence to form a cell core by laminating process. As shown in FIG. 1, firstly, a plurality of square anode plate electrodes 1, cathode plate electrodes 2 and insulation films 3 having a specific dimension are made. Secondly, an anode plate electrode 1, an insulation film 3 and a cathode plate electrode 2 are repeatedly laminated in sequence. After finishing the lamination, all of the anode (cathode) tabs 4 are welded together and then connected to a pole 6 on a housing 5.

Such square laminated cell has a disadvantage of lower production efficiency. Typically, it takes about 5 to 10 seconds to make a laminated unit consisting of an anode plate electrode, an insulation film and a cathode plate electrode. Thus, laminating of several tens of laminated units will take 10 to 20 minutes. Furthermore, since it is loose between layers, it is difficult to control the spacing between an anode plate electrode and a cathode plate electrode, so that the spacing between layers is fluctuated greatly. Therefore, the uniformity of cell is poor. Generally, the difference between the cell capacities caused by the laminating process is about ±2%.

### SUMMARY OF THE INVENTION

The present disclosure aims to provide a Li-ion power cell, which may avoid the problem of lower production efficiency of large capacity cell made by the laminating process.

To solve the above problem, the present disclosure provides a Li-ion power cell comprising at least two winding cores produced by a winding process. Each of the winding cores has an anode tab and a cathode tab. The anode tabs and the cathode tabs of the respective winding cores are connected in parallel, respectively.

The winding core is of cylindrical or diamond shape.

A winding pin of the cylindrical winding core adopted in the winding process has a circular cross section, or a winding pin of the diamond winding core adopted in the winding process has a diamond cross section.

The Li-ion power cell further includes a housing, an anode pole and a cathode pole which are disposed on the housing. The anode tabs of the respective winding cores are connected in parallel and then electrically connected to the anode pole, and the cathode tabs of the respective winding cores are connected in parallel and then electrically connected to the cathode pole.

The anode pole and the cathode pole are fixed at the opposite ends of the housing, respectively. The parallel connected cathode tabs or the parallel connected anode tabs of the respective winding cores are fixedly and directly connected to the cathode pole or the anode pole.

The anode pole and the cathode pole are fixed at the same end of the housing, and the parallel connected cathode tabs or the parallel connected anode tabs of the respective winding cores are fixedly connected with the other end of the housing and are electrically connected to the cathode pole or the anode pole through the housing.

The respective parallel connection of the anode tabs and the cathode tabs of the respective winding cores may be achieved by fixedly connecting the anode tabs of the respective winding cores to a sheet metal and fixedly connecting the cathode tabs of the respective winding cores to another sheet metal.

The fixed connection is achieved by a laser welding process.

The anode tab and the cathode tab protrude outward from the opposite ends of the respective winding cores, respectively.

Compared with the prior art, the above technical solutions have the following advantages. The above Li-ion power cell achieves an increased cell capacity with multiple winding cores connected in parallel and produced by the winding process. Currently, one winding core will be made every 5 to 10 seconds by the automatic winding equipment, and it only takes 30 to 60 seconds to connect multiple winding cores in parallel. However, in the conventional laminating process, an anode plate electrode and a cathode plate electrode are firstly cut into a number of square sub-plate electrodes, respectively; then, these sub-plate electrodes and insulation films are laminated repeatedly in sequence; and all of the anode tabs or the cathode tabs are welded together to form a cell core after laminating. The laminating action generally takes 5 to 10 seconds. Taking a cell which has 40 layers of anode sub-plate electrode, 41 layers of cathode sub-plate electrode and 83 layers of insulation films as well as 5 seconds per laminating action as an example, it will take 13.7 minutes to perform all of the laminating actions, while it will take at most 1.5 minutes to produce a cell core which has three parallel connected winding cores and has the same capacity. It is apparent that the production efficiency is significantly improved.

Besides, in the Li-ion power cell according to the disclosure, the winding process of the winding core is formed by automatic winding machine. Thus, a tension applied to the anode plate electrode, the cathode plate electrode and the insulation film may be controlled, so the spacing between the anode plate electrodes and the cathode plate electrodes of the winding core is constant. On the contrary, each plate electrode isn't subject to a tension control in the laminating process, so the spacing between the layers is different. Therefore, the Li-ion power cell in the embodiment can ensure the uniformity of winding during producing, so that the difference between cell capacities is less than ±0.5%.

### BRIEF DESCRIPTION OF THE DRAWINGS

The above and further objects, features and advantages of the present disclosure will become more apparent from the following description tri connection with the drawings, in which like reference numerals denote like parts. It should be noted that the drawings are not drawn in the same scale as actual size and plays emphasis on illustrating the spirit of the disclosure.

FIG. 1 is a schematic structural view of a power cell in the prior art;

FIG. 2 is a schematic view showing an inner structure of a Li-ion power cell according to an embodiment of the disclosure;

FIG. 3 is a schematic view showing an assembled structure of the Li-ion power cell according to the embodiment of the disclosure:

FIG. 4 is a schematic exploded view of a winding core of the Li-ion power cell in FIGS. 2 and 3;

FIG. 5 is a flowchart of a manufacture method for the Li-ion power cell in FIGS. 2 and 3;

FIG. 6 is a schematic view showing a winding pin of the Li-ion power cell according to the embodiment of the disclosure.

### DETAILED DESCRIPTION OF THE INVENTION

To better understand the above objects, features and advantages of the present disclosure, the specific embodiments of the present disclosure will be described in detail with reference to the drawings.

In the following description, many specific details are explained for fully understanding the present disclosure. However, the present disclosure may be implemented in other embodiments which are different from that described therein. Therefore, the present disclosure is not limited by the following disclosed specific examples.

The present disclosure is described in detail with reference to the schematic drawings. When describing the examples of the present disclosure in detail, the section view representing the structure of the device will be partially enlarged instead of a normal scale for illustrating. Besides, the schematic drawings are only illustrative and not intended to limit the protection scope of the disclosure. In addition, the three-dimensional space size including length, width and depth will be taken into account in the actual product.

Typically, the conventional power cell is made by the multilayer laminating process. The outstanding disadvantage lies in lower production efficiency. Generally, the production of one cell will take 10 to 20 minutes. Furthermore, since laminated structure is relatively loose, it is difficult to control the spacing between layers, so that the uniformity of cell capacity is poor.

In view of this, the Li-ion power cell of the disclosure can increase the cell capacity by using N (N is a positive integer) winding cores connected in parallel inside the cell. The winding core is produced by the winding process. Thus, it can not only ensure the essential performance of cell, but also significantly improve the production efficiency and the uniformity of cell capacity. Furthermore, the power cell may be packaged by the conventional rectangular parallelepiped rigid housing so as to save the space of battery.

Specifically, Li-ion power cell comprising at least two winding cores produced by a winding process. Each of the winding cores has an anode tab and a cathode tab. The anode tabs and the cathode tabs of the respective winding cores are connected in parallel, respectively. The winding core is of cylindrical or diamond shape.

A winding pin of the cylindrical winding core adopted in the winding process has a circular cross section, or a winding pin of the diamond winding core adopted in the winding process has a diamond cross section.

Preferably, the Li-ion power cell further includes a housing, an anode pole and a cathode pole which are disposed on the housing, and the anode tabs of the respective winding cores are connected in parallel and then electrically connected to the anode pole, and the cathode tabs of the respective winding cores are connected in parallel and then electrically connected to the cathode pole.

Optionally, the anode pole and the cathode pole are fixed at the opposite ends of the housing, respectively, and the parallel connected cathode tabs or the parallel connected anode tabs of the respective winding cores are fixedly and directly connected to the cathode pole or the anode pole.

Optionally, the anode pole and the cathode pole are fixed at the same end of the housing, and the parallel connected cathode tabs or the parallel connected anode tabs of the respective winding cores are fixedly connected with the other end of the housing and are electrically connected to the cathode pole or the anode pole through the housing.

The respective parallel connection of the anode tabs and the cathode tabs of the respective winding cores may be achieved by fixedly connecting the anode tabs of the respective winding cores to a sheet metal and fixedly connecting the cathode tabs of the respective winding cores to another sheet metal. The fixed connection is achieved by a laser welding process.

The anode tab and the cathode tab protrude outward from the opposite ends of the respective winding cores, respectively.

Hereinafter, the specific embodiments of the Li-ion power cell will be described in detail with reference to the drawings.

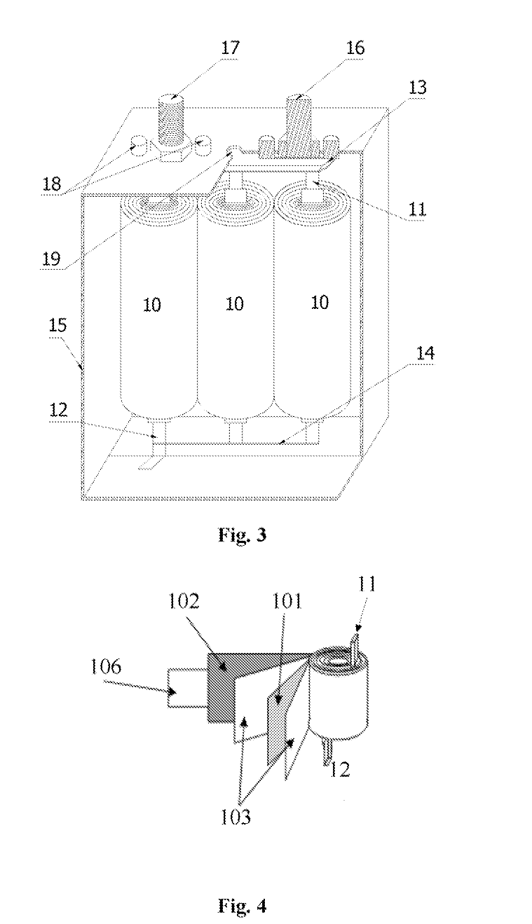

FIG. 2 is a schematic view showing an inner structure of the Li-ion power cell according to an embodiment of the disclosure, FIG. 3 is a schematic view showing an assembled structure of the Li-ion power cell according to the embodiment of the disclosure, and FIG. 4 is a schematic exploded view of a winding core of the Li-ion power cell.

As shown in FIG. 2, the Li-ion power cell includes at least two cylindrical winding cores 10 (three winding cores are shown in FIG. 2) produced by winding process. The winding core 10 has an anode tab 11 and a cathode tab 12. The anode tabs 11 and the cathode tabs 12 of the respective winding cores 10 are connected in parallel, respectively.

The parallel connection may be achieved by fixedly connecting the anode tab 11 of each winding core 10 to a sheet metal 13 and fixedly connecting the cathode tab 12 of each winding core 10 to another sheet metal 14. The fixed connection may be achieved by, for example, laser welding process.

As shown in FIG. 4, the winding core 10 is formed by laminating an anode plate electrode 101, an insulation film 103 and a cathode plate electrode 102 in sequence and then winding the lamination around a cylindrical winding pin. The anode tab 11 is connected to the anode plate electrode 101, and the cathode tab 12 is connected to the cathode plate electrode 102. The anode tab 11 and the cathode tab 12 protrude outward from the two ends of the cylindrical winding core, respectively. These wound plate electrodes are held together by an adhesive tape 106.

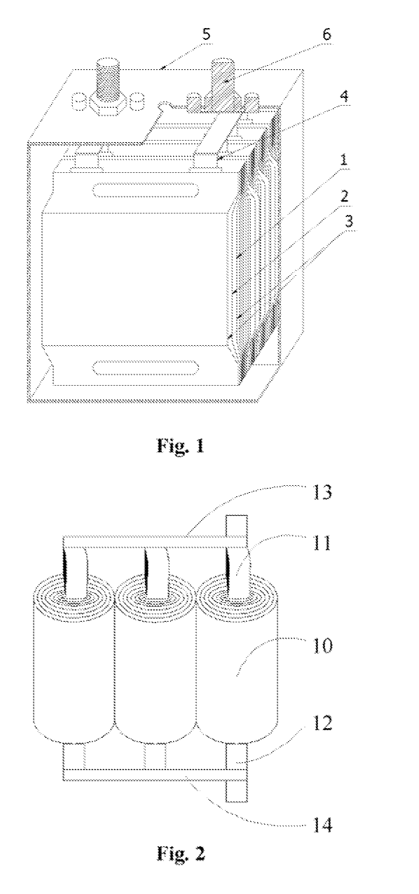

As shown in FIG. 3, the Li-ion power cell further includes a housing 15, an anode pole 16 and a cathode pole 17 which are disposed on the housing 15. The housing 15 is a rectangular parallelepiped rigid housing. The housing 15 may be the conventional rectangular parallelepiped housing of the power cell shown in FIG. 1.

The winding cores 10 connected in parallel are located inside the housing 15. The anode tabs 11 of the respective winding cores 10 are connected in parallel by the sheet metal 13 and then electrically connected to the anode pole 16. The cathode tabs 12 of the respective winding cores 10 are connected in parallel by the sheet metal 14 and then electrically connected to the cathode pole 17.

As shown in FIG. 3, the anode pole 16 and the cathode pole 17 are fixed at the same side of the housing 15. The anode pole 16 is insulated with respect to the housing 15 via a rubber plate (not shown), while the cathode pole 17 is electrically connected to the housing 15. The sheet metal 13 and the anode pole 16 are fixedly connected such that the anode tabs 11 of the respective winding cores 10 are connected in parallel first and then connected to the anode pole 16. The sheet metal 14 is fixedly connected within the other end of the housing 15 such that the cathode tabs 12 of the respective winding cores 10 are connected in parallel first and then connected to the housing 15. The housing is made of conductive material such as metal. Thus, the parallel connected cathode tabs 12 are electrically connected to the external cathode pole 17 through the housing 15. The anode pole 16 and the cathode pole 17 are fixed on the surface of the housing with rivets 18. Similarly, the anode pole and the cathode pole may be exchanged. That is, the anode pole is electrically connected to the housing, while the cathode pole is insulated with respect to the housing. In this way, the parallel connected anode tabs are electrically connected to the housing, while the parallel connected cathode tabs are electrically connected to the cathode pole. The specific structure will be omitted herein.

In addition, an explosion-proof hole 19 is also provided in the housing 15.

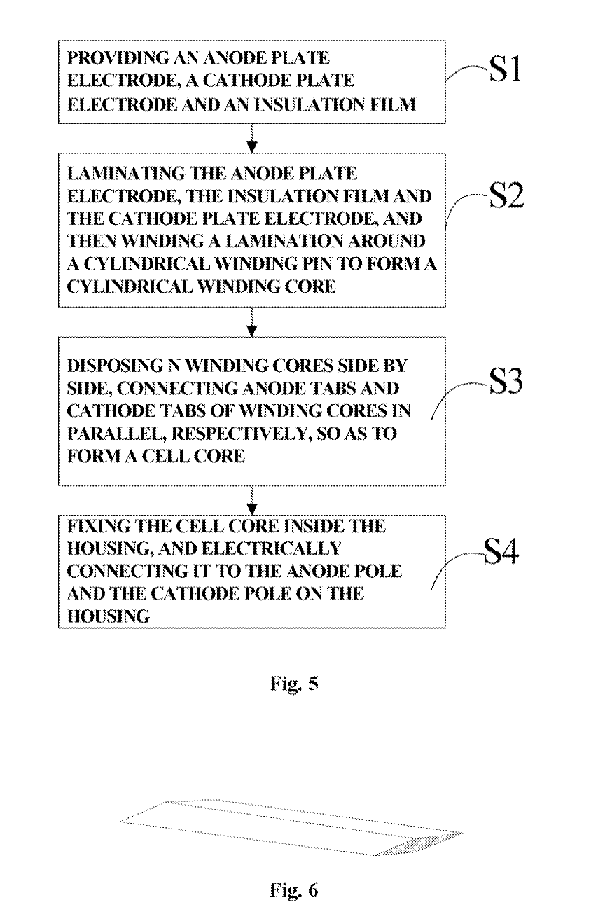

FIG. 5 is a flowchart of a manufacture method for the Li-ion power cell. The method comprises the following steps:

Step S1: providing an anode plate electrode, a cathode plate electrode and an insulation film;

Step S2: laminating the anode plate electrode, the insulation film and the cathode plate electrode and then winding the lamination around a cylindrical winding pin to form a cylindrical winding core. This step may be performed by automatic winding machine;

Step S3: disposing N (N is a positive integer) winding cores side by side depending on the designed capacity, and connecting the anode tabs and the cathode tabs of the respective winding cores in parallel, respectively, so as to form a cell core;

Step S4: fixing the cell core inside the housing, and electrically connecting it to an anode pole and a cathode pole on the housing.

The above Li-ion power cell achieves an increased cell capacity with multiple winding cores connected in parallel and produced by the winding process. Currently, one winding core will be made every 5 to 10 seconds by the automatic winding equipment, and it only takes 30 to 60 seconds to connect multiple winding cores in parallel. However, in the conventional laminating process, an anode plate electrode and a cathode plate electrode are firstly cut into a number of square sub-plate electrodes, respectively; then, these sub-plate electrodes and insulation films are laminated repeatedly in sequence; and all of the anode tabs or the cathode tabs are welded together to form a cell core after laminating. The laminating action generally takes 5 to 10 seconds. Taking a cell which has 40 layers of anode sub-plate electrode, 41 layers of cathode sub-plate electrode and 83 layers of insulation films as well as 5 seconds per laminating action as an example, it will take 13.7 minutes to perform all of the laminating actions, while it will take at most 1.5 minutes to produce a cell core which has three parallel connected winding cores and has the same capacity. It is apparent that the production efficiency is significantly improved.

Besides, the winding process of the winding core is formed by automatic winding machine. Thus, a tension applied to the anode plate electrode, the cathode plate electrode and the insulation film may be controlled, so the spacing between the anode plate electrodes and the cathode plate electrodes of the winding core is constant. On the contrary, each plate electrode isn't subject to a tension control in the laminating process, so the spacing between the layers is different. Therefore, the Li-ion power cell in the embodiment can ensure the uniformity of winding during producing, so that the difference between cell capacities is less than ±0.5%.

In another embodiment of the disclosure, the anode pole and the cathode pole are fixed at opposite ends of the housing, respectively. Besides, the anode pole and the cathode pole are insulated with respect to the housing via the rubber plate. The anode tab and the cathode tab are correspondingly positioned in two end surfaces of respective cylindrical winding cores, respectively. Thus, the cathode tabs of the respective winding cores are connected in parallel and then fixedly connected to the cathode pole through the sheet metal. The anode tabs of the respective winding cores are connected in parallel and then fixedly connected to the anode pole through the other sheet metal. The specific structure is similar to that of the above embodiment, and thus omitting its detailed description therein.

In the above embodiments, the winding cores of power cell are of cylindrical shape, and are formed by laminating the anode plate electrode, the insulation film and the cathode plate electrode and then winding the lamination around the cylindrical winding pin. Besides, the winding core may have a cross section of other shapes, such as diamond or rectangular shape.

The winding pin has a cross section of diamond shape as shown in FIG. 6. In the winding process, the anode plate electrode, the insulation film and the cathode plate electrode are laminated and then wound around the diamond winding pin so as to form a diamond winding core. The anode tabs and the cathode tabs of multiple winding cores thus formed are connected in parallel, respectively.

Compared with the conventional flat winding pin having a rectangular cross section, the diamond winding pin has a larger thickness. Thus, the length of the wound anode and the cathode plate electrodes may be increased in the housing having particular dimension. Since the cell capacity mainly depends on the application amount of the anode plate electrode, increasing the length of the anode plate electrode means increasing the cell capacity.

The above description is only the preferred embodiments of the disclosure, and is not intended to limit the disclosure in any way.

While the disclosure has been disclosed as above by way of the preferred embodiments, it is not intended to limit the disclosure. For those skilled in the art, many variations and modifications or equivalents may be made to the technical solutions of the disclosure by using the above-disclosed method and technical contents without departing from the scope of the technical solutions of the disclosure. Therefore, any simple variation, equivalent and modification made to the above embodiments according to the technical content without departing from the contents of the technical solutions of the disclosure, falls into the protection scope of the technical solutions of the present disclosure.

1. A Li-ion power cell comprising at least two winding cores produced by a winding process, wherein each of the winding cores has an anode tab and a cathode tab, the anode tabs and the cathode tabs of the respective winding cores are connected in parallel, respectively.

2. The Li-ion power cell according to claim 1, wherein the winding core is of cylindrical or diamond shape.

3. The Li-ion power cell according to claim 2, wherein a winding pin of the cylindrical winding core adopted in the winding process has a circular cross section, or a winding pin of the diamond winding core adopted in the winding process has a diamond cross section.

4. The Li-ion power cell according to claim 1, further comprising a housing, an anode pole and a cathode pole which are disposed on the housing;
wherein the anode tabs of the respective winding cores are connected in parallel and then electrically connected to the anode pole, the cathode tabs of the respective winding cores are connected in parallel and then electrically connected to the cathode pole.

5. The Li-ion power cell according to claim 4, wherein the anode pole and the cathode pole are fixed at the opposite ends of the housing, respectively, and the parallel connected cathode tabs or the parallel connected anode tabs of the respective winding cores are fixedly and directly connected to the cathode pole or the anode pole, respectively.

6. The Li-ion power cell according to claim 4, wherein the anode pole and the cathode pole are fixed at the same end of the housing, and the parallel connected cathode tabs or the parallel connected anode tabs of the respective winding cores are fixedly connected with the other end of the housing and are electrically connected to the cathode pole or the anode pole through the housing.

7. The Li-ion power cell according to claim 1, wherein the respective parallel connection of the anode tabs and the cathode tabs of the respective winding cores is achieved by fixedly connecting the anode tabs of the respective winding cores to a sheet metal and fixedly connecting the cathode tabs of the respective winding cores to another sheet metal.

8. The Li-ion power cell according to claim 5, 6 or 7, wherein the fixed connection is achieved by a laser welding process.

9. The Li-ion power cell according to claim 1, wherein the anode tab and the cathode tab protrude outward from the opposite ends of the respective winding cores, respectively.

10. The Li-ion power cell according to claim 6, wherein the fixed connection is achieved by a laser welding process.

11. The Li-ion power cell according to claim 7, wherein the fixed connection is achieved by a laser welding process.
